(19) United States
(12) Patent Application Publication
(10) Pub. No.: US 2023/0375142 A1
(43) Pub. Date: Nov. 23, 2023

(54) PROTECTION DEVICE FOR A HIGH-PRESSURE HYDROGEN TANK

(71) Applicant: FAURECIA SYSTEMES D'ECHAPPEMENT, NANTERRE (FR)

(72) Inventors: Pauline RIVIERE, MULHOUSE (FR); Damien ILTIS, BELFORT (FR)

(21) Appl. No.: 18/031,373

(22) PCT Filed: Oct. 13, 2021
(86) PCT No.: PCT/EP2021/078257

§ 371 Date: Apr. 12, 2023

(30) Foreign Application Priority Data
Oct. 13, 2020 (FR) FR20 10442

(51) Int. Cl. F17C 13/08

(52) U.S. Cl. CPC F17C 13/084; F17C 2221/012; F17C 2205/0308; F17C 2223/036; F17C 2270/0178; F17C 2201/0109; F17C 2201/056; F17C 2203/0614; F17C 2205/0305; F17C 2205/0323; F17C 2270/0184

(57) ABSTRACT

A protection device comprises a base having a general shape obtained by rotation about a longitudinal axis. The base is intended to be assembled with a hydrogen tank. The protection device comprises at least two legs extending from the base parallel to the longitudinal axis of the base.

### CROSS-REFERENCE TO RELATED APPLICATIONS

This application is the US national phase of PCT/EP2021/078257, which was filed on Oct. 13, 2021 claiming the benefit of French Application No. 20 10442, filed on Oct. 13, 2020, which is incorporated herein by reference in its entirety.

### FIELD OF THE DISCLOSURE

The present disclosure relates to a protection device for a high-pressure hydrogen tank.

### BACKGROUND

Such a hydrogen tank is, for example, intended to equip a hydrogen vehicle or a hybrid vehicle, such a vehicle comprising a fuel cell supplied with hydrogen.

The tank usually has a generally cylindrical shape defined along a longitudinal axis, extending between first and second end walls. The first end wall is generally provided with a valve.

A hydrogen tank is usually provided with a protection cap, generally made of foam, which is intended to protect the tank from impacts. However, such a protection cap is not sufficient to protect the hydrogen tank in the event of a vertical fall on one of the end walls, on a baseplate, or on the valve. Such a vertical drop may damage the tank or cause a leak.

The disclosure aims in particular to improve the protection of a hydrogen tank, by proposing a protection device capable of protecting the tank in the event of a vertical fall.

### SUMMARY

For this purpose, the disclosure relates to a protection device for a high-pressure hydrogen tank, comprising a base having a general shape obtained by rotation about a longitudinal axis, the base being intended to be assembled with the hydrogen tank, characterized in that the protection device comprises at least two legs extending from the base parallel to the longitudinal axis of the base.

The protection legs make it possible to avoid a direct impact of the tank or of a valve of the tank on the ground in the event of a fall.

A protection device according to the disclosure may comprise one or more of the following features, taken alone or according to any technically conceivable combination.
Each leg comprises a proximal end connected to the base, and a free distal end.
Each leg has a thickness, measured in a direction perpendicular to a radial direction perpendicular to the longitudinal axis, and perpendicular to a longitudinal direction parallel to the longitudinal axis, the thickness of the leg in the vicinity of the base being greater than the thickness of the leg in the vicinity of the free end.
At least one of the legs is integral with the base.
At least one of the legs is releasably connected to the base.

The disclosure likewise relates to a high-pressure hydrogen-storage system, comprising a tank delimiting a storage volume, the tank extending along a longitudinal axis between first and second end walls, and comprising a baseplate passing through the first end wall, and comprising at least one protection cap, each of which is attached to one of the respective first and second end walls, and wherein the high-pressure hydrogen-storage system further comprises at least one protection device as defined above, each of which is assembled with one of the respective protection caps.

A high-pressure hydrogen-storage system according to the disclosure may comprise one or more of the following features, taken alone or according to any technically conceivable combination.
The protection device is capable of being assembled with the protection cap in a first configuration, wherein this protection device is rotatable about the longitudinal axis of the tank.
The protection device comprises a lock to lock the rotation of the protection device, for example by snap-fastening or screwing.
The high-pressure hydrogen-storage system comprises a protection device provided on the tank on the side of the first end wall, wherein the legs of this protection device have a length greater than that of the baseplate in the direction of the longitudinal axis, or, when the baseplate comprises a valve, a length greater than that of the valve in the direction of the longitudinal axis.
The high-pressure hydrogen-storage system comprises a protection device at each of the first and second end walls of the tank.

### BRIEF DESCRIPTION OF THE FIGURES

Various aspects and benefits of the disclosure will be brought to light in the following disclosure, given solely by way of non-limiting example and made with reference to the appended figures, among which:

FIG. 1 is an axial sectional view of a hydrogen-storage system according to a first embodiment of the disclosure;

FIG. 2 is a perspective view of the protection device of FIG. 1; and

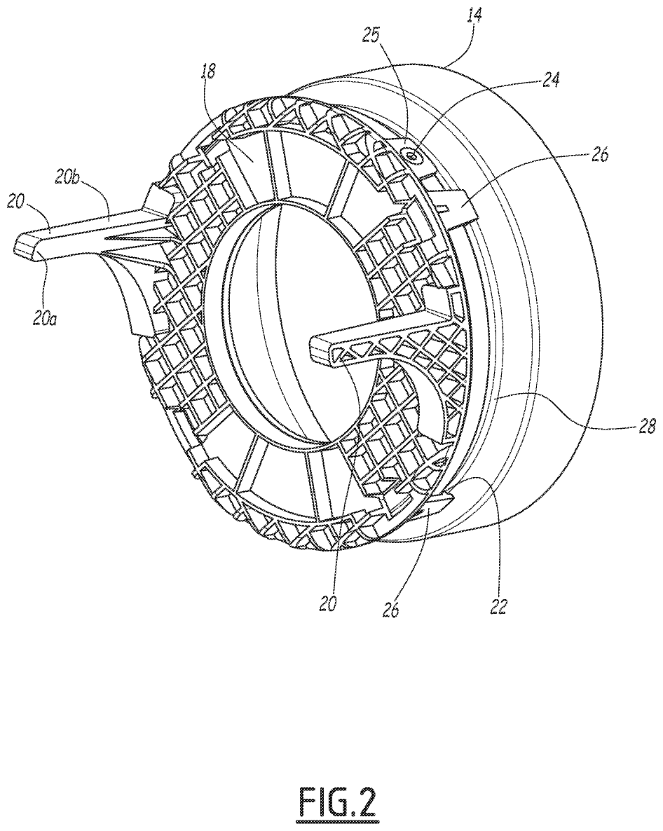

FIG. 3 is a perspective view of a protection device according to a second embodiment of the disclosure.

### DETAILED DESCRIPTION

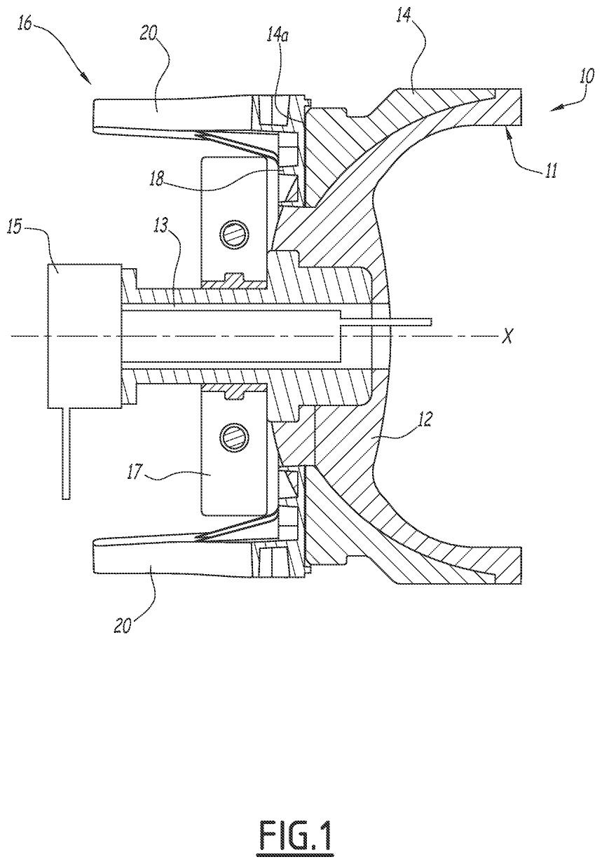

FIG. 1 partially depicts a high-pressure hydrogen-storage system 10. The storage system 10 is intended to be mounted on a structure 17, in particular a vehicle structure.

The storage system 10 comprises a high-pressure hydrogen tank 11.

The tank 11 has a generally cylindrical shape defined about a longitudinal axis X, and extending along the longitudinal axis between a first end wall 12 and a second end wall (not shown).

The tank 11 is, for example, made of a composite material.

The tank 11 comprises a baseplate 13 carried by the first end wall 12. The baseplate 13 extends, for example, along the longitudinal axis X. A valve 15 passes through this baseplate 13.

It should be noted that the tank 11 is generally mounted with the valve 15 oriented downward. Thus, if there is a flame, the hydrogen is released under the vehicle, toward the ground.

The storage system 10 advantageously comprises a protection cap 14 provided on the tank 11. More particularly, the protection cap 14 at least partially covers an outer face of the first end wall 12.

Preferably, the storage system 10 comprises another protection cap (not shown) at least partially covering an outer face of the second end wall. This other protection cap is similar to the protection cap 14 and will therefore not be disclosed in greater detail.

The protection cap 14 comprises an outer end surface 14a.

The protection cap 14 is made of an impact-absorbing material, for example foam. Preferably, the protection cap 14 is rigidly connected to the outer face of the end wall 12, for example by gluing.

The storage system 10 according to the disclosure comprises a protection device 16 mounted on the tank 11, and for example mounted on the protection cap 14.

The protection device 16 comprises a substantially annular base 18, intended to be arranged on the protection cap 14.

The protection device 16 further comprises at least one leg 20 which extends parallel to the longitudinal axis X from one end attached to the base 18 and a free end.

In the example disclosed, in order to have minimal bulk, each leg 20 has a shape that tapers from the attached end to the free end.

More particularly, in a first part 20a, comprising the free end, the leg 20 has a width, measured in a radial direction perpendicular to the longitudinal axis X, greater than a thickness measured in a direction perpendicular to the radial direction and to a longitudinal direction.

Furthermore, the leg 20 comprises a second part 20b, extending between the first part 20a and the base 18, wherein the thickness of the leg increases from the first part 20a to the base 18. This increase follows, for example, a curved arc.

Preferably, each leg 20 has a length greater than that of the baseplate 13 in the direction of the longitudinal axis X. In other words, the distance between the ends of the leg 20 in the longitudinal direction is greater than the distance between the end wall 12 and the free end of the baseplate 13 or of the valve 15.

Preferably, the protection device 16 comprises two parallel legs 20. The two legs 20 are, by way of non-limiting example, diametrically opposed.

According to the embodiment disclosed, each leg 20 is integral with the base 18. The protection device 16 is, for example, made of plastic material. The protection device 16 is thus, for example, made by molding.

Advantageously, the protection device 16, and more particularly each leg 20 and/or the base 18, comprises stiffening cells.

The protection device 16 is connected to the tank 11, and more particularly, in the example disclosed, to the protection cap 14, according to two possible configurations.

The first configuration allows the protection device 16 to rotate about the longitudinal axis X with respect to the tank 11. In this first configuration, the protection device 16 can be rotated so as to arrange the leg(s) 20 in the desired angular position.

Indeed, when the tank 11 is mounted on the structure 17, the space available for this tank 11 is limited, so that it is preferable to be able to rotate the leg(s) 20 so that they do not interfere with the installation of the tank 11 by abutting against its environment in the structure 17. In other words, the legs 20 must be aligned with the space available in the environment of the storage system. The rotation of the legs 20 in the first configuration makes it possible to give these legs 20 the desired angular position depending on the available space. Thus, the protection device 16 does not significantly impact the bulk of the tank 11 for its integration on the structure 17 of the vehicle.

With the leg(s) 20 in the desired angular position, the protection device 16 preferably passes into the second configuration, wherein the rotation of the protection device 16 is blocked with respect to the tank 11.

For this purpose, the protection device 16 according to the first embodiment comprises, for example, snap-fastening tabs 26. Each snap-fastening tab 26 comprises a lug 22.

The protection cap 14 comprises a circumferential slot 28 with which the snap-fastening tabs 26 are intended to cooperate in the second configuration.

Advantageously, the snap-fastening tabs 26 are flexible enough to be able to be radially separated from the protection cap 14, without breaking, and thus allowing the rotation of the protection device 16.

In such an exemplary embodiment, the protection cap 14 is in the first configuration when at least one snap-fastening tab 26 (preferably several) is separated from the protection cap, allowing the rotation of the protection device 16. When the snap-fastening tabs 26 are released, they return to their inoperative position so as to pinch the protection cap 14, with the lug 22 cooperating with the circumferential slot 28.

Advantageously, the friction forces thus applied by the tabs 26 on the protective cap 14 are sufficient to prevent rotation of the protection device 16, or at least greatly limit the risks of unintentional rotation. The protection device 16 is thus in the second configuration.

More particularly, in this second configuration, the portion of the protection cap 14 between the circumferential slot 28 and the end surface 14a of the protection cap 14 is clamped between the base 18 and the lugs 22 of the snap-fastening tabs 26, which allows the protection device 16 to be blocked by friction with respect to the protection cap 14. This blocking by friction is also at least partially carried out by the action of the snap-fastening tabs 26 which are elastically biased against the protection cap 14.

According to this embodiment, this blocking can be carried out in any angular position of the protection device 16.

Such blocking by friction is generally enough to prevent unintentional rotation of the protection device 16. However, it is possible to provide, as a variant, an improvement in the blocking via screwing openings 24 arranged on the protection device 16, in particular on screwing tabs 25 extending parallel to the snap-fastening tabs 26. Thus, once in position, each screwing opening 24 receives a perforating screw which bores its receiving opening in the protection cap 14. Such a perforating screw can be received regardless of the angular position of the protection device 16.

In accordance with one variant not shown, the protection cap 14 may comprise a plurality of notches for receiving the lugs 22. In this case, the angular positions of the protection device 16 are limited by the positions of the notches, but the blocking of the rotation is improved.

For example, it is possible to provide an embodiment (not shown) wherein the protection device 16 fits into a housing provided at the end of the protection cap 14. The circumferential wall delimiting this housing then preferably comprises a plurality of notches for receiving the lugs 22.

It clearly appears that in the event of a vertical fall of the storage system 10, the impact is received by the legs 20 rather than by the baseplate 13. The legs 20 at least partially absorb the energy of the impact, and/or at least partially transmit the energy of the impact to the protection cap 14.

It should be noted that, in the event of a fall on at least one of the legs 20, this leg 20 should break under the impact. The presence of at least one broken leg on a storage system 10 therefore reveals that the tank has fallen, and that it must at least be checked before use, or replaced.

It should be noted that it is also possible to arrange another protection device 16′ on the second end wall of the tank 11, and more particularly on another protection cap 14′ covering this second end wall.

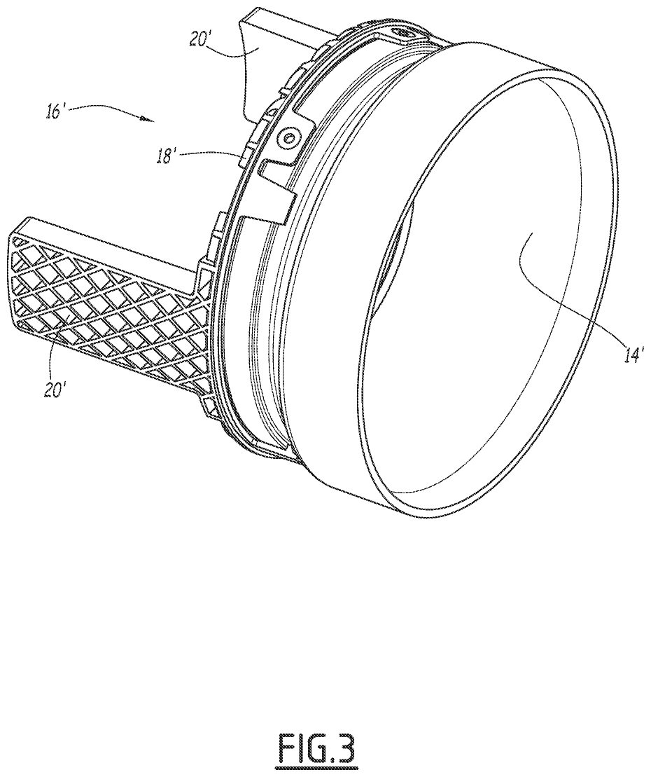

Such another protection device 16′ is depicted in FIG. 3. This other protection device 16′ is similar to the protection device 16 disclosed above, with the exception of the shape of the legs 20′, which are wider than the legs 20 of the protection device 16.

Indeed, in the structure of the vehicle, there is usually more space on the side of the second end wall of the tank 11, such that it is possible to house therein legs 20′ that are bulkier and thus sturdier.

Thus, in this other protection device 16′, the legs 20′, for example, have a substantially constant thickness from the free end of the leg 20′ up to the base 18′, the thickness being measured in a direction perpendicular to the radial direction and to a longitudinal direction.

It should be noted that the disclosure is not limited to the embodiment previously disclosed.

In accordance with one variant not shown, each leg 20, 20′ is mounted on the base 18, 18′. For this purpose, the base 18, 18′ comprises a plurality of receiving openings, each opening being shaped so as to be able to receive a relevant leg 20, 20′. Thus, the legs 20, 20′ can be arranged in different possible positions, depending on the chosen receiving openings.

In this case, it should be noted that the leg 20, 20′ can be made of another material than the base 18, 18′, for example of a metal material.

It should be noted that the protection devices 16, 16′ only vary by the shapes of their legs 20, 20′; it is thus possible to provide a base having a common shape for the two protection devices 16, 16′.

According to another variant not shown, the base of the protection device comprises two parts that are rotatable with respect to one another about the longitudinal axis X. In this case, one of the parts is attached to the protection cap, for example by gluing, while the other part comprises the legs. In this case, the protection device preferably comprises a block feature to block the rotation, for example by screwing or snap-fastening.

The disclosure has been illustrated and described in detail in the drawings and the preceding description. Same should be considered as illustrative and given as an example and not as limiting the disclosure to said description alone. Many variants of embodiment are possible.

1. A protection device for a high-pressure hydrogen tank, comprising:
a base having a general shape obtained by rotation about a longitudinal axis, the base being intended to be assembled with a hydrogen tank; and
wherein the protection device comprises at least two legs (20, 20′) extending from the base parallel to the longitudinal axis of the base.

2. The protection device according to claim 1, wherein each leg comprises a proximal end connected to the base, and a free distal end.

3. The protection device according to claim 2, wherein each leg has a thickness, measured in a direction perpendicular to a radial direction perpendicular to the longitudinal axis, and perpendicular to a longitudinal direction parallel to the longitudinal axis, the thickness of each leg in a vicinity of the base being greater than the thickness of the leg in a vicinity of the free end.

4. The protection device according to claim 1, wherein at least one of the at least two legs is integral with the base.

5. The protection device according to claim 1, wherein at least one of the at least two legs is releasably connected to the base.

6. A high-pressure hydrogen-storage system, comprising:
a tank delimiting a storage volume, the tank extending along a longitudinal axis between first and second end walls;
a baseplate passing through the first end wall, and comprising at least one protection cap, each of which is attached to one of the respective first and second end walls; and
at least one protection device according to claim 1, each of which is assembled with one of the respective protection caps.

7. The high-pressure hydrogen-storage system according to claim 6, wherein the at least one protection device is capable of being assembled with the at least one protection cap in a first configuration, wherein the at least one protection device is rotatable about the longitudinal axis of the tank.

8. The high-pressure hydrogen-storage system according to claim 7, wherein the at least one protection device comprises a block feature to block rotation of the at least one protection device.

9. The high-pressure hydrogen-storage system according to claim 8, wherein the block feature comprises snap-fastening or screwing.

10. The high-pressure hydrogen-storage system according to claim 6, comprising the at least one protection device is provided on the tank on a side of the first end wall, wherein the at least two legs of the at least one protection device have a length greater than that of the baseplate in a direction of the longitudinal axis, or, when the baseplate comprises a valve, a length greater than that of the valve in the direction of the longitudinal axis.

11. The high-pressure hydrogen-storage system according to claim 6, wherein the at least one protection device comprises a protection device at each of the first and second end walls of the tank.
